(19) United States
(12) Patent Application Publication
(10) Pub. No.: US 2026/0259143 A1
(43) Pub. Date: Sep. 3, 2026

(54) METHOD, LIGHT MICROSCOPE AND COMPUTER PROGRAM FOR LOCATING OR TRACKING EMITTERS IN A SAMPLE

(71) Applicant: ABBERIOR INSTRUMENTS GMBH, Gottingen (DE)

(72) Inventors: Roman SCHMIDT, Gottingen (DE); Andreas SCHÖNLE, Gottingen (DE); Joachim FISCHER, Karlsruhe (DE)

(21) Appl. No.: 18/994,680

(22) PCT Filed: Jul. 25, 2023
(86) PCT No.: PCT/EP2023/070633

§ 371 Date: Jan. 15, 2025

(30) Foreign Application Priority Data
Aug. 2, 2022 (DE) 10 2022 119 332.2

(51) Int. Cl. G01N 21/64; G02B 21/00

(52) U.S. Cl. CPC G01N 21/6458; G02B 21/0032; G02B 21/008

(57) ABSTRACT

The present disclosure relates to a method for localizing or tracking emitters in a sample, comprising illuminating the sample with illumination light, determining whether at least one second emitter is located in a first region in addition to a first emitter based on detected light emissions, performing an illumination sequence, wherein the sample is illuminated with an intensity distribution comprising a local minimum and at least one maximum, wherein light emissions of the first emitter are detected for the respective illumination steps, and determining the position of the first emitter from the detected light emissions, wherein the illumination sequence is adapted or specified depending on whether it has been determined that at least one second emitter is located in the first region, or wherein an estimated position of the at least one second emitter is taken into account when determining the position of the first emitter, and light microscope and computer program for carrying out the method.

### TECHNICAL FIELD

The present specification relates to a method for localizing and tracking emitters in a sample, in particular according to the MINFLUX principle or STED-MINFLUX principle, as well as to a light microscope, in particular a MINFLUX microscope or STED-MINFLUX microscope, and a computer program for carrying out the method.

### PRIOR ART

The term “MINFLUX microscopy” or “MINFLUX method” refers to certain localization and tracking methods for singulated emitters in which a light distribution of illumination light, which induces or modulates the light emission of the emitter, is generated at the focus in the sample, the light distribution comprising a local minimum, and in which the position of a singulated emitter is determined by detecting light emissions from the emitter, utilizing the fact that the smaller the distance between the emitter and the minimum of the light distribution, the less light is emitted from the emitter. Due to the latter fact, MINFLUX methods are particularly photon efficient, especially in comparison to so-called PALM/STORM localization methods. In addition, certain versions of the method also have the advantage that the emitters to be localized or tracked are exposed to relatively little light compared to other localization methods and are therefore bleached less.

The singulated light-emitting emitters are in particular fluorophores and the illumination light is in particular excitation light, which excites the fluorophores, whereupon they emit fluorescent light. Alternatively, the emitters may also be light-scattering particles, such as gold nanoparticles.

The light distribution with the local minimum may in particular be 2D-donut-shaped or 3D-donut-shaped (bottle-beam shaped).

A method of the type described above was described in patent application DE 10 2011 055 367 A1 for single molecule tracking. According to the method disclosed there, the position of a single fluorophore is tracked over time by tracking an excitation light distribution with a local minimum to the fluorophore in such a way that the fluorescence emission rate is minimized.

The patent application DE 10 2013 114 860 A1 describes in particular a localization method in which the sample is scanned at grid points with the local minimum of an excitation light distribution in order to localize individual fluorophores.

The term “MINFLUX” is used for the first time in the publication “Balzarotti F, Eilers Y, Gwosch KC, Gynnå A H, Westphal V, Stefani F D, Elf J, Hell S W. Nanometer resolution imaging and tracking of fluorescent molecules with minimal photon fluxes. Science. 2017 February 10; 355(6325): 606-612”. In the method described there, the MINFLUX principle is specifically implemented by first pre-localizing a single fluorophore by scanning it with a first Gaussian excitation light distribution and then placing a second donut-shaped excitation light distribution at points that form a symmetric pattern of illumination positions around the position of the fluorophore estimated in the pre-localization. The position of the fluorophore is then determined to within a few nanometers from the photon counts registered for the individual illumination positions using a maximum likelihood estimator.

Further variants and embodiments of MINFLUX localization are described in patent applications DE 10 2016 119 262 A1, DE 10 2016 119 263 A1 and DE 10 2016 119 264 A1.

The publication “Gwosch K C, Pape J K, Balzarotti F, Hoess P, Ellenberg J, Ries J, Hell S W. MINFLUX nanoscopy delivers 3D multicolor nanometer resolution in cells. Nat Methods. 2020 February; 17(2): 217-224” describes iterative 2D and 3D MINFLUX localization methods. Here, the sample is illuminated in several iteration steps at illumination positions with the minimum of a donut-shaped excitation light distribution, wherein the illumination positions form a symmetrical illumination pattern centered around the position of the fluorophore estimated in the previous step, and wherein the illumination positions are placed closer around the currently estimated position of the fluorophore in each iteration step. This makes it possible to achieve very high positioning accuracy in just a few steps.

Another iterative MINFLUX localization and tracking method using a modified position estimator and based on a commercial microscope setup is described in “Schmidt R, Weihs T, Wurm C A, Jansen I, Rehman J, Sahl S J, Hell S W. MINFLUX nanometer-scale 3D imaging and microsecond-range tracking on a common fluorescence microscope. Nat Commun. 2021 Mar. 5; 12(1): 1478”.

The light that induces or modulates the light emission of the emitters can also be STED (stimulated emission depletion) light, for example. For example, patent applications DE 10 2017 104 736 A1 and EP 3 372 989 A1 describe MINFLUX-type methods based on superimposing an excitation light distribution with a local maximum on a STED light distribution with a local minimum. The sample is scanned by shifting the STED distribution with the STED minimum and the position of the fluorophore is determined from the measured values of the fluorescence intensity at different positions of the STED intensity distribution. In contrast to the MINFLUX method described above, the fluorophore emits more light as the distance from the local minimum decreases. Such methods are also referred to as “STED-MINFLUX methods”.

The patent application WO 2020/128106 A1 and the publication “Masullo L A, Steiner F, Zähringer J, Lopez L F, Bohlen J, Richter L, Cole F, Tinnefeld P, Stefani F D. Pulsed Interleaved MINFLUX. Nano Letters 2021, 21 (1), 840-846” describe, among other things, embodiments of MINFLUX localization methods in which the positions at which the sample is illuminated with the minimum of the excitation light distribution are fixed by arrangements of optical fibers, wherein the excitation light is generated by a pulsed laser, and wherein individual excitation light pulses are emitted with a time delay through the different fiber ends of the optical fibers.

The publication “Masullo L A, Lopez L F, Stefani F D. A common framework for single-molecule localization using sequential structured illumination. Biophysical Reports 2022 2(1), 100036” describes a variant of the MINFLUX technique called RASTMIN, in which a small area within a microscopic field of view containing a single emitter is scanned in a Cartesian grid with the minimum of a donut-shaped excitation light distribution, and the position of the emitter is determined from the detected light intensities.

In the publication “Slenders E, Vicidomini G. ISM-FLUX: single-step MINFLUX with an array detector. bioRxiv; 2022. DOI: 10.1101/2022.04.19.488747” describes a MINFLUX method in which the light emitted by a single fluorophore is detected in a position-dependent manner using an array detector in order to determine the position of the fluorophore in a single localization step non-iteratively, without repositioning the illumination pattern and without pre-localization.

The publication “Brakemann, T., Stiel, A., Weber, G. et al. A reversibly photoswitchable GFP-like protein with fluorescence excitation decoupled from switching. Nat Biotechno/29, 942-947 (2011). https://doi.org/10.1038/nbt.1952” describes a fluorescence emitter (a variant of the green fluorescent protein) that can be excited, activated and reversibly inactivated by irradiation with light of three different wavelengths.

In some of the MINFLUX methods described in the prior art, the sample is first illuminated with activation light in order to convert fluorophores in a specific area of the sample into the fluorescent state. In other known MINFLUX methods, the sample is scanned with illumination light in a pre-localization step. If a fluorescence signal is detected above the background in this method, this is interpreted as an indication of the presence of a fluorophore. At the position where the sample was exposed to activation light or at the position where fluorescence was detected, the sample is then illuminated with the intensity distribution of the illumination light to perform localization or tracking of a single fluorophore.

With these methods, it is not possible to determine whether there is actually a single fluorophore or several fluorophores at the illuminated area of the sample.

If two or more fluorophores are actually localized or tracked with a MINFLUX method according to the prior art, two main cases can occur: Either one of the two fluorophores goes into a dark state, e.g. due to bleaching, or diffuses out of the measurement range, or both fluorophores are colocalized on the time scale of the measurement. In the first case, one of the fluorophores is further localized or tracked; in the second case, an average position of the two fluorophores is obtained.

With the MINFLUX methods according to the prior art, other fluorophores in the vicinity of the measuring range are not taken into account. The illumination sequence is always adjusted to one fluorophore only.

In order to obtain a steep intensity gradient around the minimum of the excitation light distribution, relatively high excitation light powers must be used in MINFLUX methods. As a result, the light intensity at the maximum of the excitation light distribution is so high that fluorophores that come within the range of this maximum can bleach relatively quickly. In 3D MINFLUX methods in particular, this affects not only fluorophores in the focal plane but also those located axially above or below the focal plane, as the light distributions used in these methods (in particular so-called 3D donuts or bottle beams) have strong maxima above and below the geometric focus.

Fluorophores around the measurement area are therefore very likely to be irreversibly bleached in conventional MINFLUX methods. This prevents the localization or tracking of these fluorophores in a subsequent MINFLUX step. The localization maps obtained from several MINFLUX steps therefore often have a localization density that is too low and does not adequately reflect the actual distribution of the fluorophores in the sample.

Furthermore, the excitation of fluorophores in the vicinity of the measuring range can contribute to background fluorescence due to the maximum of the excitation light distribution. This type of background fluorescence is inhomogeneously distributed and thus contributes to a systematic error in MINFLUX localization, which is difficult to correct and increases the uncertainty of the localization.

A similar problem exists with multi-color localization and multi-color single molecule tracking according to the MINFLUX principle. Here, the excitation of a first fluorophore with the maximum of the intensity distribution can lead to an interfering signal in the detection channel of a second fluorophore if the emission spectra of the first and second fluorophore overlap. This interference (also known as cross-talk) is problematic even with slight spectral overlaps, as the excitation intensity at the maximum exceeds the intensities near the minimum with which the second fluorophore is excited in the MINFLUX illumination sequence many times over. This leads to systematic errors in multicolor MINFLUX methods.

### OBJECTIVE

This results in the objective of improving a method for localizing or tracking emitters according to the MINFLUX principle in such a way that photobleaching, background fluorescence and/or crosstalk into other detection channels is reduced.

### SOLUTION

This objective is attained by the subject matter of the independent claims. Advantageous embodiments are the subject of the subclaims and are described below.

### DESCRIPTION

A first aspect of the disclosure relates to a method for localizing or tracking emitters in a sample, comprising illuminating the sample with illumination light, in particular excitation light, wherein the illumination light induces or modulates light emissions from emitters in the sample, detecting the light emissions from a first region in the sample, determining whether at least one second emitter is located in the first region in addition to a first emitter to be localized or tracked with an illumination sequence comprising a plurality of illumination steps, based on the detected light emissions, performing the illumination sequence, detecting the light emissions from a second emitter to be localized or tracked with a plurality of illumination steps, based on the detected light emissions, and carrying out the illumination sequence, wherein the sample is illuminated in the illumination steps in each case with an intensity distribution of the illumination light or of another light which induces or modulates light emissions of the emitters, wherein the intensity distribution comprises a local minimum and at least one maximum, such that the sample is illuminated in the illumination steps at at least one point with different light intensities, wherein the local minimum of the intensity distribution is positioned in a second region around a presumed position of the first emitter in the sample in the illumination steps (in particular wherein the second region is smaller than the first region), wherein light emissions of the first emitter are detected for the respective illumination steps, and determining the position of the first emitter in the sample from the light emissions detected for the respective illumination steps. According to a first alternative, the illumination sequence is adapted or specified depending on whether it has been determined that at least one second emitter is located in the first region. According to a second alternative, an estimated position of the at least one second emitter is taken into account when determining the position of the first emitter.

The term “emitter” refers to molecules, molecular complexes or particles that emit light when illuminated with the illumination light. The emitted light may in particular be fluorescent light, Rayleigh scattered light or Raman scattered light. In particular, an emitter can be regarded as a point light source in the case of diffraction-limited imaging with a light microscope, i.e. it has an extent in the range of the diffraction limit of optical microscopy or below. The emitters may be, for example, individual fluorophores (fluorescent dyes), molecules or molecule complexes labeled with one or more fluorophores or so-called quantum dots. The fluorescent dyes may be bound to the molecules by covalent or non-covalent interactions. Biological macromolecules such as proteins, for example, are often detected by binding to antibodies, which in turn are covalently linked to fluorescent dyes. Furthermore, an emitter within the meaning of the present disclosure may also be, for example, a light-scattering nanoparticle, such as a gold nanoparticle.

The terms “first emitter” and “second emitter” are used in the context of this disclosure merely to distinguish with which emitter the illumination sequence is performed in order to localize or track it and of which other emitters in the sample the position is estimated in order to take them into account with regard to photobleaching, background and/or cross-talk into other detection channels when localizing or tracking the first emitter. Of course, the first emitters and the second emitters may belong to the same species, i.e. in particular have the same excitation and emission spectrum and the same emission lifetime. However, they may also belong to different species. Of course, in the method according to the present disclosure, an emitter that belongs to the “second emitter” category in a first localization step in which another emitter is localized can be counted as belonging to the “first emitter” category in a subsequent second localization step, since it is itself localized in this step.

In the context of the present application, “localization” is understood to mean a method in which a position (in one to three dimensions) of an emitter in a sample is determined, wherein the emitter may be arranged essentially stationary in the sample, in particular on the time scale of the experiment. During localization, the emitter may of course move relative to a reference system given by the objective, for example by drift, which can be compensated for by known compensation methods. In particular, the position of a molecule, molecular complex and particle marked with the emitter may be determined by the position of the emitter during localization. In the practice of localization microscopy, a large number of emitters are usually localized in the sample one after the other and an image of structures in the sample is calculated from the individual localizations.

In contrast, “tracking” an emitter refers to the determination of several positions of the emitter over time, wherein the emitter can move relative to other sample structures in particular. This method, also known as “tracking”, can be used to create trajectories of individual molecules labeled with fluorescent dyes, for example. In particular, this allows dynamic processes to be investigated.

The illumination sequence comprises several illumination steps, in each of which the minimum of the intensity distribution of the illumination light is arranged at different positions in the second region around the presumed position of the first emitter or in which different intensity distributions are arranged at the same position or at different positions in the second region. In all cases described, certain positions in the sample are exposed to different light intensities, in particular along an intensity gradient. A presumed position of an emitter can then be calculated using a position estimator from at least two measurements of the light emissions and the known positions and courses of the intensity distribution or distributions.

According to one embodiment, the local minimum of the intensity distribution is positioned, in particular successively, at illumination positions forming an illumination pattern in the illumination sequence, wherein the illumination positions of the illumination pattern are arranged in the second region around the presumed position of the at least one emitter, in particular wherein the illumination positions are arranged on a scanning circle or a scanning sphere around the presumed position or the illumination pattern is a grid of illumination positions.

According to a further embodiment, the illumination sequence comprises the sequential illumination of the sample with at least two different intensity distributions.

Since an intensity distribution with a local minimum is used to localize or track the emitters, the method according to the present disclosure may in particular be a so-called MINFLUX method. The illumination light may be excitation light which induces the light emissions of the emitters, wherein in particular the light emissions of the emitters may be fluorescence emissions which occur due to excitation of the emitters with the excitation light. The MINFLUX method then utilizes the fact that the smaller the distance of this emitter from the local minimum of the intensity distribution of the excitation light, the lower the light emissions of an individual emitter. In particular, this has the advantage of an especially high information content of the light emissions. Alternatively, light that modulates the light emissions, e.g. STED (stimulated emission depletion) light or inactivation light, may also be used as illumination light in the MINFLUX process. In a so-called STED-MINFLUX process, this is then combined with focused excitation light. In this case, the light emissions induced by the excitation light depend on the distance of the actual emitter position from the local minimum of the light that modulates the light emissions in such a way that the smaller this distance is, the more light emissions occur.

According to the present disclosure, the illumination sequence is adapted or specified depending on whether it has been determined that at least one second emitter is located in the first region, or an estimated position of the at least one second emitter is taken into account when determining the position of the first emitter.

In MINFLUX methods and STED-MINFLUX methods according to the prior art, prior information is required about the location of the first emitter, which is then localized in one or more illumination sequences by detecting its light emissions. The preliminary information may consist of the fact that a certain point of the sample has been exposed to activation light or it may originate from a pre-localization, which is carried out, for example, by scanning the sample with focused excitation light and detecting the light emissions.

In accordance with the present disclosure, it is also determined whether there are further, second emitters in the first region which could interfere with the localization or tracking of the first emitter. Optionally, the location of at least one further second emitter in the sample is also determined with at least low resolution. From this additional information, conclusions can be drawn in particular as to how the intensity distribution of the illumination light is positioned relative to the at least one second emitter in the subsequent illumination sequence.

The second emitter may be an emitter of interest whose position is to be determined with the highest possible accuracy after the position of the first emitter, e.g. in order to obtain a localization microscopic image, or which is to be tracked after the first emitter. In this case, the illumination sequence can be carried out using the additional information about the position of the second emitter, in particular in such a way that the first emitter can be localized with high accuracy and yet the second emitter is not bleached or only bleached with low probability, so that an illumination sequence for the second emitter can then be carried out.

But even if the second emitter does not have to or should not be localized at all, the method according to the present disclosure can be used to carry out the illumination sequence in particular in such a way that background light emanating from the second emitter is minimized.

If the first emitter and the at least one second emitter are different emitter types, for example having a different excitation and/or emission spectrum, the illumination sequence may in particular also be carried out in such a way that the second emitter is not or only minimally excited by the maximum of the illumination light, so that the crosstalk of the light emissions of the second emitter into a detection channel of the first emitter is minimized.

When determining the illumination sequence according to the present disclosure, various parameters can be adapted or specified depending on whether at least one second emitter has been identified in the first region. For example, the number and/or the position of illumination positions of an illumination pattern at which the local minimum of the intensity distribution is arranged during the illumination sequence may be set. The maximum extent of the illumination pattern may also be adjusted, for example. Furthermore, the intensity distribution itself may be adjusted, e.g. by adjusting the overall intensity. An increase in the overall intensity leads, for example, to a steeper intensity gradient around the local minimum, while a lower overall intensity leads to a flatter gradient but a lower risk of bleaching the at least one second emitter. If the illumination sequence is performed in several iterations, the number of iteration steps, the change in the maximum extent of the illumination pattern and/or the overall intensity in the individual iteration steps may also be adjusted, for example. Another option for adjusting the illumination sequence is to set the length of the illumination steps or a limit value for the detected light emissions (in particular a photon limit), after which the next step is carried out. Furthermore, the selection of the region in the sample around which an illumination pattern is arranged also falls under the definition of the illumination sequence. Since in many MINFLUX methods an illumination pattern is positioned around an estimated position of an emitter, this may in particular also include the selection of one of several emitters as the first emitter with which the illumination sequence is performed.

Determining the illumination sequence may also consist in particular of not performing an illumination sequence for a specific sample region. Then, for example, the positions of the at least one second emitter (and in particular also of the first emitter) may be estimated again at a later time (in particular after the illumination sequence has been carried out at a different location). Under certain circumstances, a much more favorable relative distribution of the active emitters in the sample with regard to photobleaching, background and crosstalk into other detection channels may result at this time. The previously recorded light emissions may still be saved and possibly taken into account when determining the position later.

As an alternative to specifying the illumination sequence, the estimated position of the at least one second emitter (i.e. the additional information obtained in advance) may also be taken into account when determining the position of the first emitter. In particular, this may mean that a calculation method used to determine the position of the first emitter is adapted so that the position of the at least one second emitter is also included in the calculation. For example, correction terms may be derived from the position of the at least one second emitter, which represent the influence of the background light emitted by the at least one second emitter or the influence of crosstalk of the light emissions of the at least one second emitter into a detection channel of the first emitter.

In particular, at least one time series of the detected light emissions may be recorded, i.e. in particular stored in a memory unit. Further in particular, a separate time series of the detected light emissions may be recorded for each illumination position. Further information may then be obtained from such data, in particular combined with the estimated position of the at least one second emitter. In particular, the position of the first emitter may be corrected in a separate calculation step carried out after the illumination sequence in order to obtain even greater accuracy. For example, a point in time during the illumination sequence may be determined at which the second emitter has bleached or changed to a reversible inactive state. The correction of the background emission emanating from the second emitter or the crosstalk into the detection channel of the first emitter may then be carried out in particular only for the data originating from a time interval of the illumination sequence in which the second emitter emitted light.

According to one embodiment, when adapting or specifying the illumination sequence, an overall intensity of the illumination light is set depending on whether it has been determined that at least one second emitter is located in the first region. In particular, the overall intensity may be reduced if it has been determined that at least one second emitter is located in the first region. Although this may reduce the speed of localization, since fewer light emissions are induced per unit of time, it advantageously reduces the risk of photobleaching of the at least one second emitter.

According to a further embodiment, a position of the at least one second emitter in the sample is estimated based on the light emissions detected from the first region of the sample, wherein the illumination sequence is adapted or specified based on the estimated position or wherein the estimated position is taken into account when determining the position of the first emitter. Advantageously, by estimating the position of the at least one second emitter, the illumination sequence may be even better adapted or more favorably specified to reduce photobleaching, background and/or cross-talk.

The illumination light may be illuminated, for example in the wide field, to detect the light emissions for estimating the positions of the at least one second emitter (and optionally also of the at least one first emitter). Alternatively, area region of the sample may be scanned, for example, with a regular Gaussian focus of the illumination light or with an intensity distribution of the illumination light with a local minimum, for example with a galvanometric scanner or (especially for small scan fields) with electro-optical deflectors. Instead of scanning the light beam over the sample (so-called beam scanning), a sample holder may of course also be moved relative to a stationary light beam (so-called stage scanning). The detection light (the light emissions) may also be de-scanned, but this may not be necessary, especially when using a detector with several detector elements.

The light emissions for estimating the positions of the at least one second emitter (and optionally also of the first emitter) may be detected using a detector with multiple detector elements or using a point detector, in particular a confocal point detector. In this case, the illumination light may be scanned over the sample as described above and the detection light may be de-scanned.

According to a further embodiment, the light emissions used for estimating the positions of the at least one second emitter (and optionally also of the first emitter) may be detected with a point detector in several positions of a detection plane (in particular an image plane with respect to a focal plane of the sample), wherein the illumination light is stationary relative to the sample. In particular, the image of a confocal pinhole in the sample, e.g. on a circular path, may be scanned. This method may be realized with two independent scanning units, wherein the first scanning unit (e.g. a galvo scanner) is located in the common beam path of the illumination light and the detection light, i.e. it de-scans the detection light, while the second scanning unit (e.g. consisting of electro-optical deflectors) is positioned in the illumination beam path, i.e. it scans the illumination light over the sample but does not de-scan the detection light. Then, for example, the first scanning unit may scan the image of the pinhole in the sample on a circular path, while the second scanning unit compensates for the resulting circular movement of the illumination light beam by deflecting it in the opposite direction, so that the illumination light remains stationary relative to the sample.

According to a further embodiment, the position of the at least one second emitter is estimated in a pre-localization step, wherein an initial position estimation of the first emitter is further performed in the pre-localization step. In particular, in the pre-localization step, the light emissions of the first emitter and the light emissions of the at least one second emitter may be detected with the same detector, further in particular with a detector comprising a plurality of detector elements. Such a detector allows the parallel detection of light emissions from the first emitter and the at least one second emitter, including several second emitters.

According to a further embodiment, a localization map is created based on an estimated position of the first emitter, in particular the initial position estimate, and the estimated position of the at least one second emitter. A localization map is a two- or three-dimensional arrangement of estimated positions of individual emitters that represents a part of the sample. The localization map is created from several localizations, particularly of different emitters in the sample. Such a localization map does not necessarily have to be displayed on an image output unit such as a monitor; it may also simply be stored in a memory in the form of data by which the localization map could be displayed. The localization map may be created using various methods, wherein these are in particular not based on the MINFLUX or STED-MINFLUX principle. The localization map may therefore be generated in particular before the MINFLUX localization according to the present disclosure by a further independent method. In particular, this may have a lower resolution or a higher position uncertainty compared to the MINFLUX or STED-MINFLUX method. The localization map may, for example, be created using a detector with several detector elements arranged in an image plane representing a plane in the sample. Alternatively, the localization map may also be generated, for example, by scanning a sample area with an intensity distribution (e.g. a Gaussian focus or an intensity distribution with a local minimum) of excitation light and detecting light emissions for different scanning positions. The localization map has the advantage that the relative arrangement of different emitters may be read or determined directly and easily.

According to a further embodiment, the localization map is created using a stochastic localization method. The term “stochastic localization method” refers to a method in which a localization map of the particles is created from a plurality of localizations of singulated particles in the sample with a resolution below the diffraction limit (so-called Abbe limit, which is determined by the wavelength of the light and the numerical aperture of the objective), wherein the particles or emitters coupled to the particles change stochastically between an emitting state and a non-emitting state. In particular, the conditions may be set so that those particles or emitters that are in the emitting state in a localization have a distance above the diffraction limit. The stochastic transition between the non-emitting state and the emitting state may, for example, be induced by illuminating the sample with activation light, as is known from the so-called PALM technique (photoactivated localization microscopy). Alternatively, the chemical conditions in the sample may be adjusted so that the particles or emitters blink at a desired frequency, i.e. spontaneously switch between the emitting and non-emitting state. This is utilized, for example, in the so-called dSTORM technique (direct stochastic optical reconstruction microscopy) and in the SOFI technique (superresolution optical fluctuation imaging), wherein in the latter technique an autocorrelation function is used in particular during data evaluation in order to separate individual emitters from one another. Thus, according to one embodiment, light emissions from the at least one emitter are recorded several times in succession, with the localization map then being created from several data sets.

According to a further embodiment, the localization map has a resolution below a diffraction limit. The diffraction limit of light microscopy (also known as the Abbe limit) depends on the wavelength of the light and the numerical aperture of the objective. A resolution below the diffraction limit offers the possibility of resolving objects with a smaller extension than the diffraction limit, and is therefore synonymous with a better resolution than the diffraction limit.

According to a further embodiment, the light emissions of the first emitter and/or the at least one second emitter are detected with a detector comprising several detector elements, in particular a camera or a two-dimensional arrangement of photodiodes (e.g. a so-called array of APDs, avalanche photodiodes). The detector elements may detect the light emissions in a detection plane, in particular in a position-specific manner. The detection plane may in particular be confocal to a focal plane in the sample, which contains a geometric focus of the illumination light, i.e. the detection plane is an image plane with respect to the focal plane in the sample. In particular, the detector elements of the detector may be individually readable.

This has the advantage that the light emissions of several emitters may be detected in parallel if the area covered by the detector elements is large enough and if the optical imaging into the detection plane is appropriate. Based on these light emissions, the positions of several second emitters or both the first emitter and the at least one second emitter can be estimated in parallel.

The position of an isolated emitter may be estimated, for example, as is known from stochastic localization microscopy (in particular PALM/STORM and SOFI), by determining a centroid of a distribution of light emissions detected by the detector elements or by fitting a function (e.g. a two-dimensional Gaussian function) to such a distribution. Alternatively, for example, a statistical moment (in particular the first moment) of such a distribution may also be determined or a position estimator, e.g. a maximum likelihood estimator or a least-mean-square estimator, may be used.

In particular, the light emissions may be recorded at several consecutive points in time so that several distributions of light emissions are obtained. These may, for example, reflect different states of the emitters. For example, it is possible to record several distributions on a time scale on which the emitters blink, i.e. spontaneously change between an active state and an inactive state. In this way, emitters that are closer together than the diffraction limit of light microscopy may be displayed separately. This principle is also used in certain methods of stochastic localization microscopy (e.g. PALM/STORM).

According to a further embodiment, individual photons detected by the detector elements are registered. This has the advantage that the detector with the plurality of detector elements may be used not only for the initial estimation of the positions of the at least one second emitter, but also for detecting the light emissions during the illumination sequence for localizing the first emitter, i.e. during MINFLUX or STED-MINFLUX localization. This reduces the cost and complexity of the light microscope according to the present disclosure.

According to a further embodiment, the arrival times of the individual photons are determined using the detector with the multiple detector elements or using evaluation electronics coupled to the detector. Further information may be derived from this. For example, time series of the detected photons may provide information about the presence of further emitters in the area of the illumination sequence.

According to a further embodiment, the individual photons are assigned to individual emitters in the sample based on a correlation analysis. In this way, several emitters may be localized in parallel under certain circumstances.

According to a further embodiment, at least one relative position between the initial position estimate or the presumed position of the first emitter and the estimated position of the at least one second emitter is determined, wherein the illumination sequence is adapted depending on the at least one relative position or the at least one relative position is taken into account when determining the position of the first emitter.

Such relative positions may be represented as vectors, for example. The calculation of a relative position between the initial position estimate of the first emitter and the estimated position of a respective second emitter is already possible before the illumination sequence is executed. Since the illumination positions of the illumination sequence are usually selected depending on the initial position estimate of the first emitter, the effect on the at least one second emitter can be easily determined from the calculated relative position. For example, the relative position can be used to derive how close the maximum of the intensity distribution of the illumination light comes to the at least second emitter during an illumination sequence. Based on this, the illumination sequence can be easily adjusted, for example to minimize photobleaching, background or crosstalk in other detection channels, or these effects can be taken into account afterwards when determining the position of the first emitter, in particular corrected.

According to a further embodiment, the first emitter is selected from a plurality of emitters based on the detected light emissions, in particular based on the estimated positions of the at least one second emitter, further in particular based on an evaluation of the localization map. As explained above, this is one possible way of determining the illumination sequence. For example, a first emitter may be selected which has a particularly large distance to at least one second emitter in the sample. This minimizes the effect of the illumination light on the at least one second emitter, so that it ism less likely to be bleached, contributes less to the background or contributes less to crosstalk of the light emissions into the detection channel of the first emitter, for example. The first emitter may be selected automatically, e.g. by a selection algorithm that receives a representation of the localization map as input data. The algorithm may, for example, calculate the minimum distance to neighbouring emitters for each emitter and select the emitter with the largest value or solve an optimization problem based on a simulation of the illumination sequence. It is also possible to select the first emitter using a trained machine learning algorithm, e.g. a neural network. As an alternative to automatic selection, the selection may also be made manually. For example, the localization map may be displayed to a user of the light microscope and the user may select an emitter on the localization map, for example by clicking with the mouse.

According to a further embodiment, the selected first emitter is singulated in the sample.

Singulated emitters refer to emitters that are optically separable or optically resolvable. This may mean that the respective emitter has a distance to neighboring emitters that is above the diffraction limit of light microscopy. Alternatively, it is also possible that the light emissions of the emitter are registered during a time interval in which a neighboring emitter does not emit any light, e.g. because it is in a dark state (in the case of fluorophores). In this way, emitters that are spaced below the diffraction limit but blink asynchronously may be resolved by light microscopy. This is known, for example, from stochastic localization methods such as PALM/STORM. Finally, it is also possible to resolve emitters that have a distance below the diffraction limit but emit light of different wavelengths by spectral separation of the emitted light using light microscopy or to excite two emitters with different excitation spectra with different wavelengths in order to optically separate the emitters. Similarly, emitters with different emission lifetimes may be distinguished from each other by measuring the lifetime (e.g. by time-resolved single photon counting) and thus detected separately. All of these examples fall under the term “singulated emitters”. A sample with singulated emitters may be obtained in particular by adjusting the conditions of labeling the sample with fluorescent dyes in such a way that a desired labeling density of single molecules in the sample is obtained, by targeted photoactivation of fluorescent dyes and/or by adjusting the physicochemical properties of the sample environment (e.g. by reducing agents, oxidizing agents and certain enzymes in the sample), so that a certain blinking rate of the fluorescent dyes is achieved.

If the selected first emitter is singulated, effects affecting adjacent second emitters such as photobleaching of the second emitters, additional background or crosstalk in a detection channel assigned to the first emitter may be minimized particularly well.

According to a further embodiment, it is determined based on the detected light emissions that at least one third emitter is located in the first region in addition to the first emitter, wherein the first emitter and the at least one third emitter are localized or tracked together by the illumination sequence. This possibility may relate in particular to very closely neighboring emitters that are coupled to one another, for example physically and/or with regard to their light emission. In this case, the MINFLUX or STED-MINFLUX method may be used to determine an average position. In the simplest case in this embodiment, for example, the sum of the light emissions of the first emitter and the at least one third emitter may be recorded and an average position may be determined from this. In particular, the position of the third emitter may also be estimated. For example, a moment analysis of the distribution of the light emissions over the detector elements of the detector may reveal that certain light emissions originate from several closely neighboring emitters. For this purpose, a width or a skewness of the distribution may be determined, for example. Alternatively, such information may of course also be obtained by adapting the parameters of a suitable function to the distribution of the light emissions. If a time series of the light emissions is stored, additional information may be obtained from this, particularly if the position determination is subsequently refined, e.g. if one of the at least two first emitters changes to a dark state during the illumination sequence. Furthermore, a position estimator specially adapted to the localization or tracking of several emitters may be used under certain circumstances to determine the positions of the first and the at least one third emitter simultaneously, possibly with less accuracy than for one singulated emitter.

According to a further embodiment, the first emitter and the at least one third emitter have a distance between them below the diffraction limit.

According to a further embodiment, the light emissions of the first emitter and the at least one third emitter are coupled. Here, “coupled” means that the light emissions of the emitters are correlated in time.

According to a further embodiment, the local minimum of the intensity distribution in the illumination sequence is positioned, in particular successively, at illumination positions in a common region of estimated positions of the first emitter and the at least one third emitter, in particular wherein the illumination positions may be arranged on a scanning ellipse around the estimated position, wherein a main axis of the scanning ellipse extends along a connecting line between the estimated positions of the first emitter and the at least one third emitter. In particular, the use of such an illumination pattern may result in the emitters being less likely to be in the region of the maximum of the intensity distribution during the illumination sequence. In particular, this may reduce the probability of photobleaching.

According to a further embodiment, the illumination sequence is performed, in particular depending on the estimated position of the at least one second emitter, such that the at least one maximum of the intensity distribution of the illumination light maintains a minimum distance from the at least one second emitter during the illumination sequence. This reduces the excitation of the at least one second emitter by the illumination light, which leads to a reduction in the photobleaching of the at least one second emitter, a reduction in the background caused by the at least one second emitter and/or the so-called cross-talk, i.e. the light emissions caused by the at least one second emitter but incorrectly assigned to the first emitter. The maximum of the intensity distribution may, in particular in all illumination steps of the illumination sequence, further in particular at all illumination positions of the illumination pattern, have at least a distance from the second emitter or (in the case of several second emitters) all second emitters that corresponds to the minimum distance. The minimum distance may be a two-dimensional distance in a focal plane in the sample or a three-dimensional distance. Particularly in iterative MINFLUX methods, in which an illumination pattern is centered on a previously determined position of the first emitter in each iteration step, the illumination sequence is not fixed from the outset. In this case, in particular between iteration steps, it is possible to check whether the maximum continues to maintain the minimum distance to the at least one second emitter, and the illumination sequence may be adapted accordingly in order to fulfill this criterion. Between certain or all iteration steps, the positions of the at least one second emitter may in particular also be estimated again, wherein further in particular an updated localization map can be created.

According to a further embodiment, the intensity distribution and/or an illumination pattern of illumination positions at which the local minimum of the intensity distribution is positioned in the illumination sequence, in particular one after the other, is adjusted so that the at least one maximum of the intensity distribution maintains the minimum distance to the at least one second emitter, wherein in particular a maximum extent of the illumination pattern may be adjusted. The maximum extent may, for example, be a diameter of a scanning circle on which the illumination positions are arranged. Reducing the size of this scanning circle restricts the area in which the maximum of the intensity distribution is located in the illumination sequence. The same applies, for example, to the width or length of a regular grid of illumination positions.

According to a further embodiment, a plurality of first emitters are successively localized or tracked, wherein the illumination sequences for the plurality of first emitters are performed in an order determined dependent on the estimated position of the at least one second emitter, so that the at least one maximum of the intensity distribution of the illumination light maintains the minimum distance from the at least one second emitter. In the illumination sequences, the intensity distribution is arranged successively in the respective second regions around the respective presumed positions of the plurality of first emitters, wherein the respective light emissions of the respective first emitter are detected, and wherein the position of the respective first emitter is determined from the respective light emissions. For example, a first emitter may initially be selected which has a maximum distance from all second emitters in a partial area of the sample. In terms of protection against photobleaching, this first emitter no longer needs to be considered as a second emitter in the illumination sequence of the next first emitter, as the highly accurate localization data for the initially selected first emitter is already available. With regard to the background and the cross-talk, i.e. the carry-over of the light emissions into other detection channels, the first emitter initially selected no longer needs to be taken into account, at least if it has bleached during the execution of the illumination sequence or has switched to a reversible inactive state. It is already clear from these considerations that the sequence of position determination can play a role for effects such as photobleaching, background and cross-talk. In addition, after completion of the illumination sequence of the initially selected first emitter, a different arrangement of active emitters may be present in the sample, for example because some of the emitters have spontaneously switched between an active state and an inactive state. Therefore, in particular after the illumination sequence for the initially selected emitter, light emissions of the at least one second emitter may be detected again and the position of the at least one second emitter may be estimated, wherein further in particular an updated localization map may be created from the detected light emissions. The next first emitter may then be selected, in particular based on the updated estimate. Of course, the order of the first emitters for which illumination sequences are performed may alternatively also be determined ab initio, i.e. before the first illumination sequence. In particular, the order may be determined automatically by an optimization algorithm, e.g. based on a simulation and/or using a machine learning algorithm, e.g. a trained neural network.

According to a further embodiment, the illumination sequence performed to localize or track the first emitter is terminated or interrupted or the light intensity of the illumination light is reduced if, in particular depending on the estimated position of the at least one second emitter or an updated estimated position of the at least one second emitter, it is determined that at least one second emitter is located within a minimum distance from the maximum of the intensity distribution of the illumination light during the illumination sequence.

The termination or interruption may occur in particular when emitters are localized. The measurement may be continued in particular if an updated position estimate of the at least one second emitter, in particular an updated localization map, shows that the situation has changed in such a way that the minimum distance is now maintained, e.g. by spontaneously switching of some emitters between the active and inactive states. Reducing the light intensity of the illumination light reduces the probability of photobleaching and has the additional advantage that it can also be used during tracking without the tracked first emitter moving out of the measurement range with a high probability, as would be the case if the measurement were interrupted.

According to a further embodiment, the initial position estimate of the first emitter performed in the pre-localization step is taken into account when determining the position of the first emitter, in particular wherein the determined position may be equal to the position estimated for creating the localization map. This means in particular that the position of the first emitter may be determined with a lower accuracy than the position of other emitters, since the initial position estimation is in particular not performed using a MINFLUX method. This embodiment may be advantageous in particular if it is no longer possible to determine the position of the first emitter with high accuracy, for example because the measurement had to be aborted or if the first emitter has diffused out of the measurement range. In this case, a lower position accuracy is accepted in favor of a higher localization density.

According to a further embodiment, the first emitter and the at least one second emitter differ in their excitation spectrum and/or in their emission spectrum. Such emitters may be used, for example, for a multicolor measurement in which different sample structures are marked with different fluorescent dyes. For this constellation, the problem already discussed above arises that in an illumination sequence performed for an emitter of a first species, the maximum of the intensity distribution of the illumination light comes close to an emitter of a second species. If the excitation spectra overlap even slightly, this leads to excitation of the emitters of the second species and to light emission from these emitters. Although emission filters are often used in multicolor fluorescence microscopy, it is often not possible to completely separate the light emissions of the first and second species, so that the light emissions of the second species caused by the unwanted excitation of the second species carry over into the detection channel intended for the light emissions of the first species (so-called cross-talk). This cross-talk is particularly pronounced in multicolor MINFLUX microscopy, as it is often the case that an emitter of the first species is close to the minimum of the intensity distribution of the excitation light, while an emitter of the second species is positioned near the maximum. In this situation, the second emitter emits many more photons than the first emitter, thus contributing significantly to the cross-talk despite only a slight overlap of the emission spectrum with the detection channel. According to the present disclosure, this effect is reduced by adjusting the illumination sequence based on the prior information about the distribution of the at least one second emitter in the sample, in particular in order to reduce the cross-talk.

According to a further embodiment, a correction of the determined position of the at least one first emitter is carried out, in particular based on the estimated position of the at least one second emitter, wherein the correction takes into account an influence of light emissions of the at least one second emitter erroneously assigned to the at least one first emitter on the determined position of the at least one first emitter. The light emissions of the second emitter erroneously assigned to the first emitter may arise in particular because the first and second emitters are so close together that the at least one second emitter is excited by the illumination light during the illumination sequence for the at least one first emitter. If the first emitter and the at least one second emitter are of the same species, i.e. have the same excitation and emission spectra, this contributes to the background. If the first emitter and the at least one second emitter have different excitation spectra and/or different emission spectra, this may lead to cross-talk of the light emissions of the at least one second emitter into the detection channel for the light emissions of the first emitter. Both background and cross-talk result in a systematic error in the MINFLUX position determination. According to the embodiment described above, this error is corrected by a correction algorithm based on the estimation of the positions of the at least one second emitter (in particular the localization map).

According to a further embodiment, the illumination sequence comprises irradiating at least one second emitter with inactivation light, wherein the inactivation light causes with a certain probability a transition of the second emitter irradiated with the inactivation light into an inactive state, in particular a reversible inactive state, in which the illumination light does not induce or modulate any light emissions of the second emitter irradiated with the inactivation light. In this way, emitters can be specifically switched off so that they do not interfere with the position determination of the first emitter, in particular due to additional background or cross-talk. If the inactivation light does not lead to photobleaching but to a transition to a reversible dark state, the inactivated emitters can be localized or tracked in a later illumination sequence after a spontaneous return to the active state.

In particular, the intensity of the inactivation light may be selected such that the second emitter transitions to a reversible inactive state. Studies known from the prior art have shown that, under suitable conditions, particularly high light intensities lead to a higher probability of a transition to a reversible dark state.

A transition to a permanent inactive state caused by the inactivation light, such as photobleaching, may also be advantageous in the context of the present disclosure, particularly if an emitter is specifically inactivated after completion of the illumination sequence and position determination for this emitter, so that it does not interfere with subsequent illumination sequences for further first emitters.

According to a further embodiment, a light distribution of the inactivation light with a local minimum and at least one maximum is generated in the sample, wherein the light distribution is positioned such that the intensity of the inactivation light to which the first emitter is exposed is below a limit value. In particular, the local minimum may be positioned in a third region around a presumed position of the first emitter. This has the advantage that second emitters may be selectively inactivated, wherein the risk of photobleaching of the first emitter by the inactivation light is minimized. The light distribution may have essentially the same shape as the light distribution of the illumination light, e.g. the shape of a 2D donut or a 3D donut. This has the advantage that the same light modulator may possibly be used to modulate the illumination light and the inactivation light.

According to a further embodiment, the illumination sequence comprises irradiating at least one inactive or inactivated emitter with activation light after localization or tracking of the first emitter, wherein the activation light causes a transition of the emitter irradiated with the activation light into an active state in which the illumination light induces or modulates light emissions of the emitter. In this way, in particular, inactivated emitters may be reactivated in a targeted manner in order to localize or track them with a subsequent illumination sequence.

According to a further embodiment, a light distribution of the activation light with a local minimum and at least one maximum is generated in the sample, wherein the light distribution is positioned such that the intensity of the activation light applied to the first emitter is below a limit value. In particular, the local minimum may be positioned in a third region around a presumed position of the first emitter.

According to a further embodiment, the inactivation light differs spectrally from the illumination light, in particular the excitation light. In particular, the activation light also differs spectrally from the illumination light, in particular the excitation light. In particular, the activation light may also differ spectrally from the inactivation light.

A number of fluorescent emitters are known which can be inactivated or activated by irradiation with light of their excitation wavelength at a suitable intensity. In addition, reversibly photoswitchable fluorescent dyes are known which can be activated with light of their excitation wavelength and inactivated with light of a different wavelength and those which can be inactivated with light of their excitation wavelength and activated with light of a different wavelength. However, this has the disadvantage that either the inactivation or the activation is always coupled with the excitation of the fluorophore.

From the publication “Brakemann, T., Stiel, A., Weber, G. et al. A reversibly photoswitchable GFP-like protein with fluorescence excitation decoupled from switching. Nat Biotechno/29, 942-947 (2011). https://doi.org/10.1038/nbt.1952” a variant of the green fluorescent protein specified as “Dreiklang” is known, which can be excited, activated and reversibly inactivated by irradiation with light of three different wavelengths. The activation wavelength is around 365 nm, the inactivation wavelength is around 405 nm and the maximum of the excitation spectrum is 515 nm. The emission spectrum of this fluorescence emitter has a maximum at 529 nm.

Such emitters are particularly suitable for the method according to the present disclosure, since in this way second emitters can be selectively inactivated and reactivated without exciting them and without exciting the first emitter to be localized.

A second aspect of the present disclosure relates to a light microscope for localizing or tracking emitters in a sample, in particular according to a method according to the first aspect, comprising a light source configured to generate illumination light which induces or modulates light emissions from emitters in a sample, an illumination optics configured to illuminate the sample with the illumination light, a light modulator configured to generate an intensity distribution of the illumination light with a local minimum and at least one maximum in the sample, a detector which is configured to detect light emissions from emitters in the sample, a computing unit which is configured to determine, based on the light emissions detected by the detector, whether at least one second emitter is located in a first region in the sample in addition to a first emitter which is to be localized or tracked with an illumination sequence with a plurality of illumination steps, a control unit which is configured to control the light source, the illumination optics and/or the light modulator in such a way that the illumination sequence is carried out, wherein the sample is illuminated with an intensity distribution of the illumination light or of another light which induces or modulates light emissions of the emitters in the illumination steps, wherein the intensity distribution comprises a local minimum and at least one maximum, in such a way that the sample is illuminated in the illumination steps at at least one point with different light intensities, wherein the local minimum of the intensity distribution is positioned in a second region around a presumed position of the first emitter in the sample in the illumination steps, and wherein light emissions of the first emitter are detected for the respective illumination steps, wherein the computing unit is configured to determine the position of the first emitter in the sample from the light emissions detected for the respective illumination steps, and wherein the control unit is configured to adapt or specify the illumination sequence depending on whether it has been determined by the computing unit that at least one second emitter is located in the first region, or wherein the computing unit is configured to take into account an estimated position of the at least one second emitter when determining the position of the first emitter.

According to one embodiment of the light microscope, the computing unit is configured to estimate a position of the at least one second emitter in the sample based on the light emissions detected from the first region of the sample, wherein the control unit is configured to adjust or specify the illumination sequence based on the estimated position, or wherein the computing unit is configured to take the estimated position into account when determining the position of the first emitter.

According to a further embodiment, the light microscope comprises a detector comprising several detector elements.

According to a further embodiment of the light microscope, the light source comprises an illumination laser, in particular an excitation laser, which is configured to generate the illumination light, wherein the light source also comprises an inactivation laser which is configured to generate inactivation light, wherein the inactivation light induces a transition of the emitter, in particular second emitter, irradiated with the inactivation light into an inactive state in which the illumination light does not induce or modulate any light emissions of the at least one emitter, in particular second emitter, irradiated with the inactivation light, in particular wherein the inactivation light differs spectrally from the illumination light.

According to a further embodiment of the light microscope, the light source comprises an activation laser which is configured to generate activation light, wherein the activation light causes a transition of a second emitter irradiated with the activation light into an active state, in which the illumination light induces or modulates light emissions of the at least one emitter, in particular second emitter, irradiated with the activation light, in particular wherein the activation light differs spectrally from the illumination light. In particular, the activation light may also differ spectrally from the inactivation light.

In particular, the inactivation laser may emit light of a different wavelength than the illumination laser, in particular the excitation laser. In particular, the activation laser may emit light of a different wavelength than the illumination laser, in particular the excitation laser. In particular, the inactivation laser may emit light of a different wavelength than the activation laser.

According to a further embodiment, the light modulator or a further light modulator of the light microscope is configured to generate an intensity distribution of the inactivation light with a local minimum and at least one maximum in the sample and/or to generate an intensity distribution of the activation light with a local minimum and at least one maximum. In particular, the same light modulator may be configured to modulate the illumination light and the inactivation light and/or the activation light.

According to a further embodiment of the light microscope, the control unit is configured to position the light distribution of the inactivation light and/or the activation light in such a way that the intensity of the inactivation light or the activation light with which the first emitter is exposed is below a limit value. In particular, the control unit may be configured to position the local minimum in a third range around a presumed position of the first emitter.

A third aspect of the present disclosure relates to a non-transitory computer-readable medium for storing computer instructions for localizing or tracking emitters in a sample that, when executed by one or more processors associated with a light microscope causes the one or more processors to perform a method according to the first aspect.

Further features of the light microscope according to the second aspect and of the computer program according to the third aspect result from the features of the method according to the first aspect described above.

Advantageous further embodiments are shown in the claims, the description and the drawings and the associated explanations of the drawings. The described advantages of features and/or combinations of features of the present disclosure are merely exemplary and may have an alternative or cumulative effect.

With regard to the disclosure (but not the scope of protection) of the original application documents and the patent, the following applies: Further features can be found in the drawings in particular the relative arrangements and active compounds shown. The combination of features of different embodiments of the present disclosure or of features of different claims is also possible in deviation from the selected back relations of the claims and is hereby suggested. This also applies to those features which are shown in separate drawings or mentioned in their description.

These features can also be combined with features of different claims. Likewise, features listed in the claims can be omitted for further embodiments of the present disclosure, but this does not apply to the independent claims of the granted patent.

The reference signs contained in the claims do not constitute a limitation of the scope of the objects protected by the claims. They merely serve the purpose of making the claims easier to understand.

In the following, embodiments of the present disclosure are described with reference to the figures. These do not limit the subject matter of this disclosure and the scope of protection.

### BRIEF DESCRIPTION OF THE FIGURES

FIG. 1 shows a flow chart of the method according to the present disclosure according to an example;

FIG. 2 shows a schematic representation of an example of the method according to the disclosure;

FIG. 3 shows a schematic representation of a further example of the method according to the disclosure;

FIG. 4 shows a schematic representation of a further example of the method according to the disclosure;

FIG. 5 shows a first example of the light microscope according to the disclosure;

FIG. 6 shows a second example of the light microscope according to the disclosure;

FIG. 7 shows a third example of the light microscope according to the disclosure;

FIG. 8 shows a fourth example of the light microscope according to the disclosure.

### DESCRIPTION OF THE FIGURES

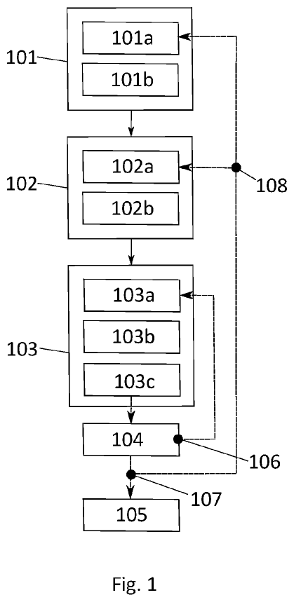

FIG. 1 shows a flow chart of the method according to the present disclosure for localizing or tracking emitters E according to an example. The method comprises a pre-localization step 101, a step 102 in which an illumination sequence 103 is determined, the illumination sequence 103, a position determination 104 and the optional creation of an image 105. Furthermore, nodes 106, 107, 108 are shown at which certain steps of the method are repeated based on a certain decision explained below, which is shown by the dashed lines and arrows.

The method comprises a MINFLUX method, which in turn comprises at least the illumination sequence 103 and the position determination 104 and in particular also the pre-localization step 101.

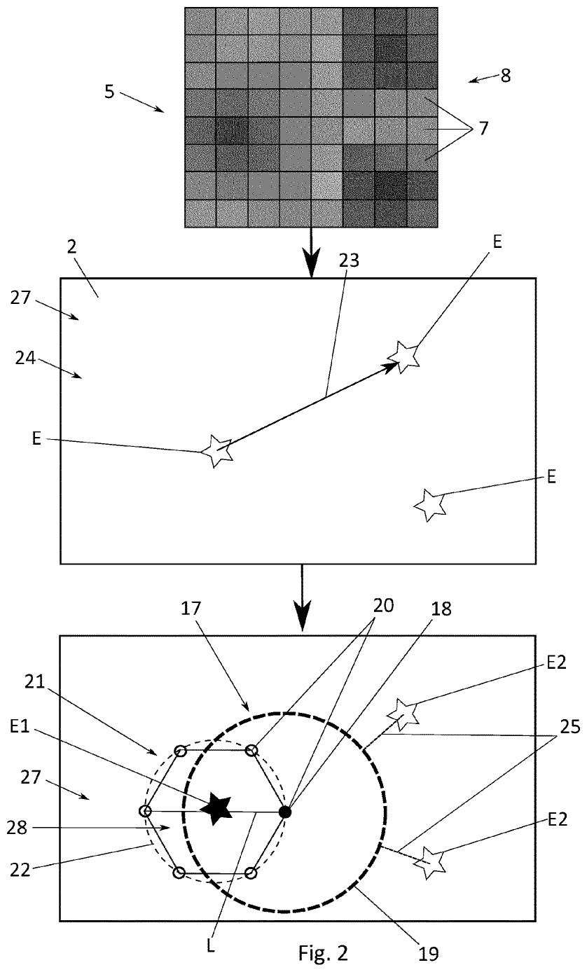

In the pre-localization step 101, light emissions D of a plurality of emitters E are first detected from a first region 27 of a sample 2 in the sub-step 101a, which are caused by illuminating the sample 2 with illumination light B, for example with a detector 5 having a plurality of detector elements 7 (see FIG. 2). The illumination light B is in particular excitation light that excites the emitters E (in this case fluorescence emitters) so that they emit fluorescence light as light emissions D. The positions of several emitters E are then estimated from the detected light emissions D, for example by centroid determination, moment determination or a function fit based on a distribution of light emissions D in a detection plane 8 detected by the several detector elements 7 (see FIG. 2). A localization map 24 may then be created from these estimated positions.

Subsequently, in the step 102, an illumination sequence 103 is adapted or specified based on the estimated positions, in particular based on the localization map 24. For this purpose, a first emitter E1, which is to be localized or tracked in the subsequent illumination sequence 103, is first selected from the multiple emitters E whose position was estimated in the pre-localization step 101 in the sub-step 102a. In the sub-step 102b, further parameters of the illumination sequence 103 may then be determined, e.g. the position, number and sequence of illumination positions 20 at which the sample 2 is illuminated with an intensity distribution 17 of illumination light B with a local minimum 18 (see FIG. 2), the overall intensity of the illumination light B and/or the shape of the intensity distribution 17.

When performing the illumination sequence 103, the sample 2 is illuminated in several illumination steps 103a, 103b, 103c with the intensity distribution 17 in accordance with the previously defined parameters. Each illumination step 103a, 103b, 103c is assigned to a different illumination position 20 at which the local minimum 18 of the intensity distribution 17 is located in the respective illumination step 103a, 103b, 103c. As a result, the sample 2 is exposed to different light intensities at a given position in the various illumination steps 103a, 103b, 103c. In particular, the illumination positions 20 form an illumination pattern 21 which is arranged around a presumed position of the first emitter E1 (see FIG. 2). The presumed position corresponds to the position of the first emitter E1 previously estimated in the pre-localization step, at least for the first defined illumination pattern 21. In particular, in the case of iterative MINFLUX methods, the presumed position may also correspond to a position determined in a previous iteration step.

In each illumination step 103a, 103b, 103c, the light emissions D of the first emitter E1 are detected by a detector 5, in particular in the form of a photon number detected in a specific time interval.

From the light emissions D recorded for the various illumination steps 103a, 103b, 103c and the associated positions of the local minimum 18 of the intensity distribution 17, a position of the first emitter E1 is then determined in step 104, for example using a maximum likelihood position estimator or a least-mean-square position estimator.

At the first node 106, it may be decided in an iterative MINFLUX method whether the illumination sequence 103 is to be repeated for the first emitter E1. In particular, the illumination pattern 21 of the illumination positions 20 is arranged around the position determined in step 104. In addition, the illumination pattern 21 may be adapted, for example by reducing a maximum extent L of the illumination pattern 21 (e.g. a diameter of a scanning circle 22, see FIG. 2) and/or by increasing an overall intensity of the illumination light B. In this way, the positional accuracy may be successively increased in the iteration steps. For example, a fixed number of iteration steps may be specified and a check may be made at the first node 106 as to whether the specified number of iteration steps has already been carried out and a decision can be made as to whether a further iteration step is carried out depending on this. Alternatively, a check may also be made at the first node 106, for example, as to whether a total number of detected and registered photons has exceeded a predetermined limit value, and a decision may be made based on this as to whether a further iteration step is to be carried out.

If the method according to the present disclosure is a localization method, a localization microscopic image is created in the step 105, in particular from the successively determined positions of a plurality of first emitters E1. If the method is used to track the position of a moving first emitter E1 in the sample over time (tracking method), a trajectory is determined in step 105, in particular from several successive localizations of the same first emitter E1. In both cases, a decision may be made at the second node 107 as to whether a further localization is to be performed or whether the image or the trajectory is to be calculated. If the method is continued, a decision may be made at the third node 108 as to whether a pre-localization step 101 is performed again and, in particular, an updated localization map 24 is created, or whether the determination 102 of the illumination sequence 103 is continued based on the previously estimated positions. In particular, when the illumination sequence 103 is determined again 102, a new first emitter E1 is selected in the case of localization in step 102a, for which the illumination sequence 103 is then performed.

FIG. 2 schematically shows an example of the method according to the present disclosure. With a detector 5 having several detector elements 7 arranged in a detection plane 8, light emissions D from emitters E in the sample 2 are detected and a localization map 24 is created, which shows the estimated positions of three emitters E, which are symbolized by stars.

From the localization map 24, one of the emitters E is selected as the first emitter E1 (see FIG. 2 below, filled-in star) and an illumination sequence 103 is defined for this first emitter E1. In this case, the illumination sequence 103 comprises six steps in which the local minimum 18 of the intensity distribution 17 of the illumination light B is arranged at different illumination positions 20 in a second region 28. The illumination positions 20 form a hexagonal illumination pattern 21 with a maximum extent L, which corresponds to the diameter of a scanning circle 22 on which the illumination positions 20 are arranged. The presumed position of the first emitter E1, which corresponds to the estimated position of the first emitter E1 shown on the localization map 24, is located at the center of the scanning circle 22. In the illumination step shown at the bottom of FIG. 2, the local minimum 18 of the intensity distribution 17 is located at the illumination position 20 marked by a filled symbol. The maximum 19 of the intensity distribution 17 runs in a circle around the local minimum 18 in the focal plane, as is the case, for example, with so-called 2D donuts and 3D donuts (also known as bottle beams).

The illumination sequence 103 is determined such that distances 25 between the maximum 19 and the estimated positions of the second emitter E2 located in the neighborhood of the first emitter E1 maintain a minimum distance for all illumination steps 103a, 103b, 103c of the illumination sequence 103. For this purpose, the localization map 24 may be evaluated by a computing unit 10. Furthermore, relative positions 23 between the first emitter E1 and the respective second emitters E1 may be determined with the aid of the localization map 24 and the position estimates and taken into account when determining the illumination sequence 103. Such a relative position 23 is indicated by a vector in FIG. 2.

In particular, the minimum distance is such that photobleaching of the second emitters E2 is avoided as far as possible. This makes it more likely that the second emitters E2 can be localized or tracked with high accuracy in a subsequent MINFLUX process, which improves the localization density.

Maintaining the minimum distance between the maximum 19 and the estimated positions of the second emitters E2 may also serve to ensure that the second emitters E2 are excited as little as possible by the illumination light B, so that as few light emissions D as possible occur from the second emitters E2, which are incorrectly assigned to the first emitter E1. If the second emitters E2 have the same excitation and emission spectrum as the first emitter E1, the background can be reduced in this way. In a multicolor localization or tracking method in which the first emitter E1 and the second emitters E2 belong to different species whose excitation and/or emission spectra differ, the crosstalk of the light emissions D of the second emitters E2 into a detection channel intended for the first emitter E1 can thus be reduced.

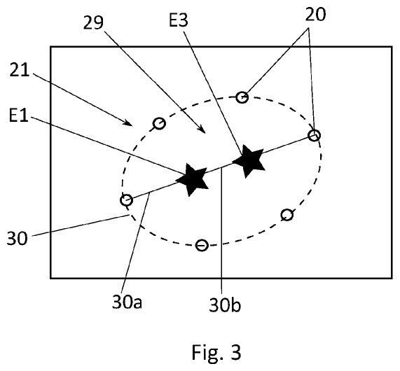

FIG. 3 shows a special illumination pattern 21 according to an example of the method according to the present disclosure. In this case, based on the light emissions D detected in the pre-localization step 101, it was determined that, in addition to the first emitter E1, a further, third emitter E3 is located in its immediate vicinity. In particular, the third emitter E3 is arranged so close to the first emitter E1 that the first emitter E1 cannot be localized or tracked using a MINFLUX method without simultaneously inducing light emissions D from the third emitter E3. Therefore, a common illumination sequence 103 is performed for the first emitter E1 and the third emitter E3. For this purpose, the minimum 18 of the intensity distribution 17 of the illumination light B is arranged at illumination positions 20 in a common region 29 around the first emitter E1 and the third emitter E3. The illumination positions 20 form the illumination pattern 21 and lie here on a scanning ellipse 30. A main axis 30a of the scanning ellipse 30 runs along the connecting line between the presumed positions of the first emitter E1 and the third emitter E3, and the center 30b of the scanning ellipse 30 lies at a center of gravity of the presumed positions of the first emitter E1 and the third emitter E3. The joint position determination of the first emitter E1 and the third emitter E3 may provide an average position of the first emitter E1 and the third emitter E3, which in particular has a lower positional accuracy than for individual emitters. Alternatively, the first emitter E1 or the third emitter E3 may bleach during the illumination sequence 103. In this case, the remaining emitter can then be further localized or tracked with greater accuracy.

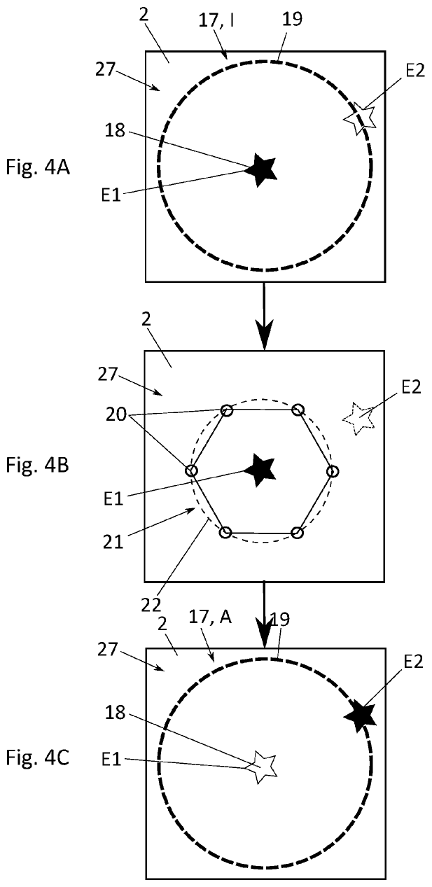

FIG. 4A to FIG. 4C show a further example of the method according to the present disclosure, in which a second emitter E2 is placed in a non-emitting state by irradiation with inactivation light I (FIG. 4A), the illumination sequence 103 is then carried out with the first emitter E1 (FIG. 4B) and the second emitter E2 is then transferred back to the active, emitting state by irradiation with activation light A (FIG. 4C). As a result, the illumination sequence 103 can be performed for the first emitter E1 without irreversibly bleaching the second emitter E2 and without the second emitter E2 contributing to the background or cross-talk. Subsequently, for example, the re-activated second emitter E2 may be selected as the new first emitter E1 and the illumination sequence 103 may be performed with the second emitter (not shown). Bleaching of the first emitter E1 would be acceptable here, since the position data of the first emitter E1 is already available. Alternatively, of course, the first emitter E1 may be inactivated after the step shown in FIG. 4C, e.g. to reduce the background or cross talk when localizing or tracking the second emitter E2.

In the steps shown in FIG. 4A and FIG. 4C, the sample 2 is exposed to an intensity distribution 17 of the inactivation light I or the excitation light A, which comprises a local minimum 18 and a ring-shaped maximum 19 in the focal plane. The minimum 18 is located in each case at the presumed position of the first emitter E1 and the maximum 19 is located in particular at the presumed position of the second emitter E2. As a result, the second emitter E2 is inactivated or activated with particularly high efficiency, while the first emitter E1 remains protected from potential damage by the inactivation light I and the activation light A.

As indicated in FIG. 4B, the illumination sequence 103 comprises the illumination sequence 103 shown in FIG. 2, in which an illumination pattern 21 of six illumination positions 20 arranged on a scanning circle 22 around the presumed position of the first emitter E1 is used. The local minimum 18 of an intensity distribution 17 of the illumination light B is arranged at the illumination positions 20.

The inactivation light I may differ spectrally from the activation light A. In addition, both the inactivation light I and the activation light A may differ spectrally from the illumination light B, in particular the excitation light. The inactivation and activation may therefore be decoupled from the excitation. Suitable emitters for this purpose are known from the prior art, as described above.

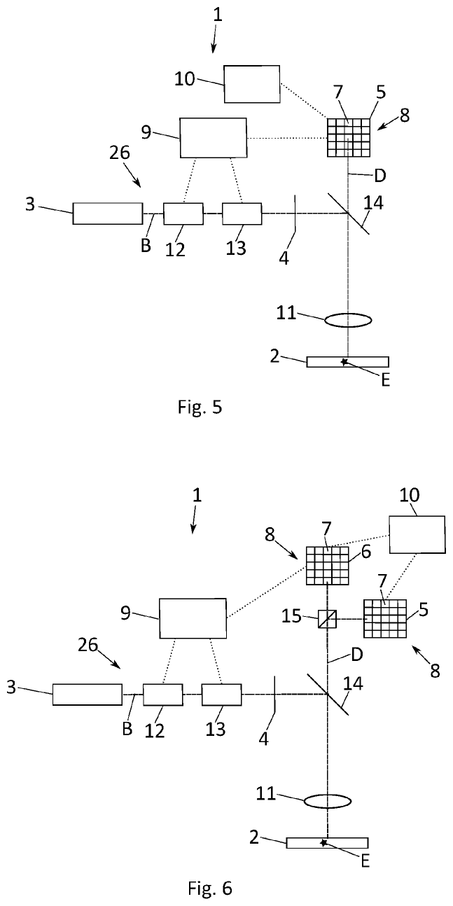

FIG. 5 shows an example of a light microscope 1 for localizing or tracking emitters E in a sample 2 according to the method of the present disclosure. The light microscope 1 is a MINFLUX microscope that comprises a light source 3 with a laser that generates an illumination light beam of illumination light B. The illumination light beam passes through a first beam displacement unit 12 and a second beam displacement unit 13, e.g. two electro-optical deflectors (EODs) forming a part of an illumination optical system 26 and deflecting the illumination light beam respectively in a first direction and a second direction orthogonal to the first direction in a plane extending perpendicular to a propagation direction of the illumination light beam (also referred to as x-direction and y-direction), when the first beam deflection unit 12 and the second beam deflection unit 13 receive a corresponding control signal from the control unit 9.

Furthermore, the illumination light beam is modulated, in particular phase-modulated, by a light modulator 4 of the illumination optics 26 in order to generate an intensity distribution 17 with a local minimum 18 (in particular a 2D donut or a 3D donut) at the focus in the sample 2 (see FIG. 2). The light modulator 4 may be transmitted by the illumination light beam, as shown as an example in FIG. 5. Alternatively, the illumination light beam may also be refracted by a diffraction grating of the light modulator 4 or reflected by a surface of the light modulator 4 and thereby phase-modulated.

The illumination optics 26 further comprises a dichroic mirror 14, which reflects the phase-modulated illumination light beam, and an objective lens 11, which focuses the illumination light beam into the sample 2.

The emitters E in the sample 2 excited by the illumination light B emit fluorescent light (light emissions D), which transmits the dichroic mirror 14 due to its wavelength and reaches a detector 5 of the light microscope 1. The detector 5 comprises a plurality of detector elements 7, which are arranged in a detection plane 8 extending perpendicular to the direction of propagation of the light emissions D.

In particular, the detector elements 7 detect individual photons emitted by the emitter E, which are registered by a computing unit 10 of the light microscope 1 or the detector 5. The detector 5 may be a camera or a SPAD array, for example.

In order to obtain the estimated positions of the emitters E in the pre-localization step 101 and in particular to create the localization map 24, the sample 2 is illuminated with illumination light B, in particular excitation light. This may be the same illumination light B that is used to perform the illumination sequence 103, or a different illumination light. In particular, wide-field illumination of the sample 2 by the light source 3 or another light source (not shown) may be provided for the pre-localization step. Alternatively, the sample 2 may also be scanned with focused illumination light B during the pre-localization step 101, e.g. by the first beam displacement unit 12 and the second beam displacement unit 13 or with a galvanometric scanner (not shown). Here, as in the subsequent illumination sequence 103, the intensity distribution 17 with the local minimum 18 may be used, or the sample 2 may be scanned with a different light distribution, for example a regular, approximately Gaussian focus. In the latter case, it is advantageous if the light modulator 4 comprises individually controllable pixels in order to be able to switch between an intensity distribution 17 with a local minimum 18 and a regular focus by changing the displayed phase pattern.

From the photons (light emissions D) detected by the detector elements 7 of the detector 5 in the pre-localization step 101 and registered by the computing unit 10, the computing unit 10 estimates the position of the emitters E, for example by determining a centroid of a distribution of light intensities (or photon numbers) detected by the detector elements 7. Alternatively, the position may also be estimated by the computing unit 10, e.g. by fitting a Gaussian function to the light intensity distribution of the detected light, by a maximum likelihood estimator or by moment determination.

The computing unit 10 then evaluates the localization map 24 and determines the illumination sequence 103 based on this evaluation. In doing so, the computing unit 10 first selects a first emitter E1 from several emitters E. The computing unit 10 then determines further parameters of the illumination sequence 103, such as the type of intensity distribution 17, the total intensity of the illumination light B, the type of illumination pattern 21, the number of illumination positions 20 or the maximum extent L of the illumination pattern 21 such that the maximum 19 of the intensity distribution 17 in each illumination step 103a, 103b, 103c of the illumination sequence 103 maintains the minimum distance from the estimated positions of the at least one second emitter E2. Therein, in particular, the computing unit 10 may use stored relative positions 23 between the first emitter E1 and a respective second emitter E2.

In the following illumination sequence 103, the sample 2 is illuminated with the intensity distribution 17 with the local minimum 18 at illumination positions 20, which form an illumination pattern 21 around the presumed position of the first emitter E1. The first beam displacement unit 12 and the second beam displacement unit 13 position the focus of the illumination light beam in the focal plane in the sample 2 at the illumination positions 20. For each illumination position 20, light emissions D are detected by the detector elements 7 of the detector 5. The computing unit 10 then determines the position of the first emitter E from the light emissions D.

In addition to the first beam displacement unit 12 and the second beam displacement unit 13, the light microscope 1 may comprise a further scanning unit (not shown), e.g. a galvanometric scanner, in order to reposition the intensity distribution 17 of the illumination light B over a larger image field with respect to the sample.

Such an additional scanning unit may be located in particular in the common beam path of the illumination light B and the detection light, i.e. between the objective lens 11 and the dichroic mirror 14, so that the scanning unit can both scan the illumination light B over the sample 2 and also de-scan the light emissions D of the emitters E in the sample.

If the detector 5 is a point detector and a pinhole is arranged between the dichroic mirror 14 and the detector 5, the first beam displacement unit 12, the second beam displacement unit 13 and the additional scanning unit can be controlled so that the illumination light is stationary with respect to the sample, but the detection light generated by the light emissions D of the emitters E is detected at different positions of the detection plane 8. For example, the image of the pinhole in the sample 2 can be moved with the scanning unit on a circular path, while the first beam displacement unit 12 and the second beam displacement unit 13 compensate for the resulting circular movement of the illumination light B, so that it is stationary relative to the sample 2. This method, also referred to as “pinhole orbit scanning”, can be carried out, for example, in the pre-localization step 101 in order to detect the light emissions D of several emitters E with a detector 5 configured as a point detector. In particular, the orbit scan can be performed successively at different positions of the illumination light B relative to the sample 2.

As an alternative to using the beam displacement units 12, the sample 2 may also be illuminated with the illumination light B at the various illumination positions 20, for example, successively through different optical fibers (not shown), e.g. by coupling light pulses of the illumination light B into optical fibers of different lengths, so that these have a temporal offset relative to one another. In this case, the illumination pattern 21 can be positioned relative to the sample by a scanning unit, e.g. a galvanometric scanner. Different expansions of the illumination pattern 21 in the sample 2 can be set, for example, using zoom optics or by controlling different groups of optical fibers.

FIG. 6 shows a further embodiment of the light microscope 1 according to the present disclosure (MINFLUX microscope). It is constructed analogously to the light microscope 1 shown in FIG. 5 (the same reference signs denote the same components) but comprises a first detector 5 and a second detector 6 in the detection beam path, each with several detector elements 7 arranged in a detection plane 8. The detection light, i.e. the light emissions D, are separated by a beam splitter 15. This may be a neutral beam splitter that splits the detection light in a predetermined ratio (e.g. 1:1) regardless of its properties. Alternatively, the beam splitter 15 may also be a polarization beam splitter, for example. In this case, for example, a polarization switching element (not shown), e.g. a Pockels cell, may be arranged in front of the beam splitter 15 in order to guide the detection light selectively to the first detector 5 or the second detector 6 by a control signal depending on its polarization direction.

For example, the first detector 5 may be optimized for detecting the light emissions D for estimating the positions of the emitters E in the pre-localization step 101 and the second detector 6 may be optimized for detecting the light emissions D during the illumination sequence 103. The first detector 5 may, for example, be a CCD or CMOS camera. This has the advantage that individual emitters E can be localized relatively quickly in a relatively large image field. The second detector 6 may be a SPAD array. For localization according to the MINFLUX principle, this has the particular advantage that single photon counting is possible for MINFLUX localization with an extended capture range, meaning that emitters E can be unambiguously localized in a larger area.

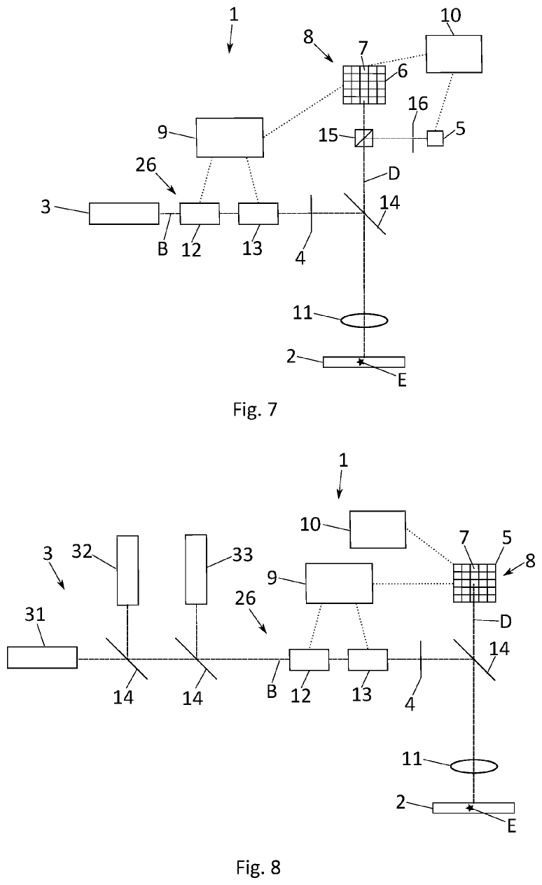

FIG. 7 shows a further embodiment of the light microscope 1 according to the present disclosure (MINFLUX microscope). It is constructed analogously to the light microscope 1 shown in FIG. 5 (the same reference signs denote the same components) but comprises a first detector 5 configured as a point detector (e.g. an avalanche photodiode) and a second detector 6 configured as an area detector with several detector elements 7 arranged in a detection plane 8 in the detection beam path. As in the example shown in FIG. 6, the detection light is also split between the first detector 5 and the second detector 6 by a beam splitter 15. The beam splitter 15 may also be a neutral beam splitter or a polarization beam splitter, for example, as described above. An optional pinhole 16 for optical sectioning (as known from confocal microscopy) is arranged between the beam splitter 15 and the first detector 5.

In the example shown in FIG. 7, the first detector 5 in particular is optimized for detecting the light emissions D of the first emitter E1 during the illumination sequence 103. The second detector 6 is optimized in particular for the pre-localization step 101, in which the light emissions D of several emitters E in a first region 27 of the sample 2 are detected depending on the position.

FIG. 8 shows a light microscope 1 (MINFLUX microscope) according to a further example. It is essentially constructed in the same way as the light microscope 1 shown in FIG. 5, with the same reference signs designating the same components.

The light source 3 of the light microscope 1 comprises an illumination laser 31 (in particular an excitation laser) as well as an additional inactivation laser 32 and an additional activation laser 33 for providing activation light A. The inactivation laser 32 and the activation laser 33 are coupled into the illumination beam path via respective dichroic mirrors 14 and pass through the first beam displacement unit 12, the second beam displacement unit 13 and the light modulator 4, are reflected at a further dichroic mirror 14 and are focused into the sample 2 by the objective lens 11. In this way, a focus or an intensity distribution 17 with a local minimum 18 (when the light beam is modulated by the light modulator 4) of the inactivation light I and the activation light A may be generated at desired positions in the sample 2.

In particular, the inactivation laser 32 and the activation laser 33 are switchable, i.e. the light of the corresponding laser can be switched on and off (or shaded) by a control signal from the control unit 9. For example, acousto-optical modulators may be provided for this purpose (not shown).

The light microscope 1 shown in FIG. 8 can be used in particular to implement the method illustrated in FIG. 2 and FIG. 4 and described above.

### LIST OF REFERENCE SIGNS

1 Light microscope
2 Sample
3 Light source
4 Light modulator
5 Detector, first detector
6 Second detector
7 Detector element
8 Detection plane
9 Control unit
10 Computing unit
11 Objective lens
12 First beam displacement unit
13 Second beam displacement unit
14 Dichroic mirror
15 Beam splitter
16 Pinhole
17 Intensity distribution
18 Local minimum
19 Maximum
20 Illumination position
21 Illumination pattern
22 Scanning circle
23 Relative position
24 Localization map
25 Distance
26 Illumination optics
27 First region
28 Second region
29 Common region
30 Scanning ellipse
30a Main axis
30b Center
31 Illumination laser
32 Inactivation laser
33 Activation laser
101 Pre-localization step
101a Detection of light emissions from multiple emitters
101b Creating a localization map
102 Specifying an illumination sequence
102a Selection of at least one first emitter
102b Specifying further parameters for the lighting sequence
103 Illumination sequence
103a First illumination step
103b Second illumination step
103c Third illumination step
104 Position determination
105 Creating an image or a trajectory
106 First node
107 Second node
108 Third node
A Activation light
B Illumination light
D Light emissions
E Emitter
E1 First emitter
E2 Second emitter
E3 Third emitter
I Inactivation light
L Maximum extent

1. A method for localizing or tracking emitters in a sample, comprising the following steps:
illuminating the sample with illumination light, which induces or modulates light emissions from emitters in the sample,
detecting the light emissions from a first region in the sample,
determining whether at least one second emitter is located in the first region in addition to a first emitter, which is to be localized or tracked with an illumination sequence with a plurality of illumination steps, based on the detected light emissions,
carrying out the illumination sequence, wherein the sample is illuminated in the illumination steps in each case with an intensity distribution of the illumination light or of another light which induces or modulates light emissions of the emitters, wherein the intensity distribution comprises a local minimum and at least one maximum, such that the sample is illuminated in the illumination steps at at least one point with different light intensities, wherein the local minimum of the intensity distribution is positioned in a second region around a presumed position of the first emitter in the sample in the illumination steps wherein light emissions of the first emitter are detected for the respective illumination steps, and
determining the position of the first emitter in the sample from the light emissions recorded for the respective illumination steps,
wherein the illumination sequence is adapted or specified depending on whether it has been determined that at least one second emitter is located in the first region, or that an estimated position of the at least one second emitter is taken into account when determining the position of the first emitter.

2. The method according to claim 1, wherein when adjusting or specifying the illumination sequence, an overall intensity of the illumination light is set depending on whether it has been determined that at least one second emitter is located in the first region.

3. The method according to claim 1, wherein a position of the at least one second emitter in the sample is estimated based on the light emissions detected from the first region of the sample, wherein the illumination sequence is adapted or specified based on the estimated position, or wherein the estimated position is taken into account when determining the position of the first emitter.

4. The method according to claim 3, wherein a localization map is created based on an estimated position of the first emitter, and the estimated position of the at least one second emitter.

5. The method according to claim 1, wherein the light emissions from the first region of the sample and/or the light emissions occurring during the illumination sequence are detected with a detector comprising a plurality of detector elements.

6. The method according to claim 1, wherein at least one relative position between the initial position estimate or the presumed position of the first emitter and the estimated position of the at least one second emitter is determined, wherein the illumination sequence is adapted depending on the at least one relative position or the at least one relative position is taken into account when determining the position of the first emitter.

7. The method according to claim 1, wherein the first emitter is selected from a plurality of emitters based on the detected light emissions.

8. The method according to claim 1, wherein it is determined based on the detected light emissions that a third emitter is located in the first region in addition to the first emitter, wherein the first emitter and the at least one third emitter are localized or tracked together by the illumination sequence.

9. The method according to claim 8, wherein the light emissions of the first emitter and of the at least one third emitter are coupled.

10. The method according to claim 8, wherein the local minimum of the intensity distribution is positioned, in particular successively, at illumination positions in a common region of presumed positions of the first emitter and the at least one third emitter in the illumination sequence.

11. The method according to claim 1, wherein the illumination sequence is performed, in such that the at least one maximum of the intensity distribution of the illumination light maintains a minimum distance from the at least one second emitter during the illumination sequence.

12. The method according to claim 11, wherein a plurality of first emitters are successively localized or tracked, wherein the illumination sequences for the plurality of first emitters are performed in an order determined dependent on the estimated position of the at least one second emitter, so that the at least one maximum of the intensity distribution maintains the minimum distance from the at least one second emitter.

13. The method according to claim 1, wherein the illumination sequence carried out for localizing or tracking the first emitter is terminated or interrupted or wherein the light intensity of the illumination light is reduced when it is determined.

14. The method according to claim 1, wherein the first emitter and the at least one second emitter differ in their excitation spectrum and/or in their emission spectrum.

15. The method according to claim 1, wherein a correction of the determined position of the first emitter is carried out, wherein the correction takes into account an influence of light emissions of the at least one second emitter erroneously assigned to the first emitter on the determined position of the first emitter.

16. The method according to claim 1, wherein the illumination sequence comprises irradiating at least one second emitter with inactivation light, wherein the inactivation light causes a transition of the second emitter irradiated with the inactivation light into an inactive state, in which the illumination light does not induce or modulate any light emissions of the at least one second emitter irradiated with the inactivation light.

17. The method according to claim 16, wherein the illumination sequence comprises, after localizing or tracking the first emitter, irradiating at least one inactive or inactivated emitter with activation light, wherein the activation light causes a transition of the emitter irradiated with the activation light into an active state in which the illumination light induces or modulates light emissions from the emitter.

18. The method according to claim 16, wherein the inactivation light differs spectrally from the illumination light.

19. A light microscope for localizing or tracking emitters in a sample, comprising
a light source configured to generate illumination light which induces or modulates light emissions from emitters in a sample,
an illumination optical system which is configured to illuminate the sample with the illumination light,
a light modulator which is configured to generate an intensity distribution of the illumination light with a local minimum and at least one maximum in the sample,
a detector which is configured to detect light emissions from emitters in the sample,
a computing unit which is configured to determine, based on the light emissions detected by the detector, whether at least one second emitter is located in a first region in the sample in addition to a first emitter which is to be localized or tracked with an illumination sequence with a plurality of illumination steps,
a control unit which is configured to control the light source, the illumination optics and/or the light modulator in such a way that the illumination sequence is carried out, wherein the sample is illuminated with an intensity distribution of the illumination light or of another light which induces or modulates light emissions of the emitters in the illumination steps in such a way that the sample is illuminated in the illumination steps at at least one point with different light intensities, wherein the intensity distribution comprises a local minimum and at least one maximum, wherein the local minimum of the intensity distribution is positioned in a second region around a presumed position of the first emitter in the sample in the illumination steps, and wherein light emissions of the first emitter are detected for the respective illumination steps,
wherein the computing unit is configured to determine the position of the first emitter in the sample from the light emissions detected for the respective illumination steps, and
wherein the control unit is configured to adapt or specify the illumination sequence depending on whether it has been determined by the computing unit that at least one second emitter is located in the first region, or wherein the computing unit is configured to take into account an estimated position of the at least one second emitter when determining the position of the first emitter.

20. A non-transitory computer-readable medium for storing computer instructions for localizing or tracking emitters in a sample that, when executed by one or more processors associated with a light microscope causes the one or more processors to perform a method according to claim 1.
